(19) United States
(12) Patent Application Publication
(10) Pub. No.: US 2006/0193130 A1
(43) Pub. Date: Aug. 31, 2006

(54) LED lighting system

(76) Inventor: Kazuo Ishibashi, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/349,110

(22) Filed: Feb. 8, 2006

(30) Foreign Application Priority Data
Feb. 28, 2005 (JP) JP2005-054642

(51) Int. Cl. B60Q 1/26

(52) U.S. Cl. 362/227

(57) ABSTRACT

Provided is an LED lighting system with a smaller heat resistance of the LED, which can be produced by simpler mounting steps and is capable of three-dimensionally arranging the LEDs depending on required directivity of each system. A plurality of LEDs 2 are mounted on an FPC 1 which has a radial shape and can be flat when developed. The LEDs 2 connected by printed wiring to each other and linked to terminals 3 and 4 are attached on a surface of a core 5 made of a material having a high thermal conductivity. Heat generated at a p-n junction of the LEDs 2 is transmitted to the core 5 via the FPC 1 and a thermal-conductive adhesive.

### BACKGROUND OF THE INVENTION

1. Field of the Invention

The present invention relates to an LED (light emitting diode) lighting system using a plurality of LEDs, capable of emitting light with high luminance.

2. Description of the Related Art

Since a white LED was commercialized, attempts to utilize an LED as a light source have been made. Compared to an electric bulb and a fluorescent lamp, an LED causes less power loss by thermal energy and has a longer life. Recently, white LEDs with high luminous intensity have been developed, and the application of an LED to a lighting system is becoming more realistic than the use of conventional light sources such as electric bulbs or fluorescent lamps.

In order to obtain the same illuminance and color rendering properties as those of conventional electric bulbs and fluorescent lamps, it is necessary to provide a plurality of LED elements, which are similar to point sources, arranged on one face.

Here, when employing LEDs, heat dissipation management is necessary to fully utilize the properties of LEDs. Insufficient heat dissipation considerably shortens the life and leads to failure.

The maximum temperature at which an LED can be used depends on a junction temperature (Tj) which is the temperature of a p-n junction. This junction temperature must be designed so as not to exceed the maximum standard of the junction temperature. The junction temperature Tj (° C.) is expressed in the following equation, where an ambient temperature is Ta (° C.); a thermal resistance from a p-n junction to a heat dissipater is Rja (° C./W); and a power applied to an LED is W (W):
Tj=Ta+Rja*W

To lower the junction temperature Tj, it is necessary to lower one of the ambient temperature Ta, the thermal resistance Rja and the applied power W. In order to lower the ambient temperature Ta, a cooling fan or the like can be used for air-cooling, which is, however, impractical in conventional lighting devices. Decreasing the applied power W is also meaningless because the illuminance is lowered accordingly. Therefore, a technique for lowering the thermal resistance Rja by a heat dissipation system is required.

In the case of an LED lighting system, in general, a substrate with a plurality of LEDs mounted is thermally connected to a heat sink or the like to enhance heat dissipation to the outside.

For example, Unexamined Japanese Patent Publication No. 2001-243809 discloses an LED bulb comprising a base provided on one end, a bugle-shaped metal heat radiation part expanding like a bugle toward an opening part on the other end, a translucent cover attached to an opening part of the bugle-shaped metal heat radiation part, a plate-like metal substrate provided inside of a nearly spherical body formed by the bugle-shaped metal heat radiation part and the translucent cover, and LED elements packaged on an outer surface of the metal substrate facing the translucent cover. The metal substrate is fixed to the opening part of the bugle-shaped metal heat radiation part via a high thermal-conductive insulating member.

Unexamined Japanese Patent Publication No. 2002-299700 discloses an LED illuminating device comprising a substrate with a plurality of light-emitting diodes arranged on one surface thereof, and a resin case for holding the substrate. The substrate is held by the bottom part via a heat-dissipating fastening plate, and protrusions are formed on one face of the heat-dissipating fastening plate, which is opposite to the face on which the substrate is held, so as to increase the contacting area with the bottom part of the resin case.

Unexamined Japanese Patent Publication No. 2003-31005 discloses a light-emitting diode illumination device comprising a plurality of LEDs arrayed on a concave face so as to converge the light of the LEDs and a cooling part arranged to closely contact a rear end of a substrate of the LEDs.

Unexamined Japanese Patent Publication No. 2004-327138 discloses an illumination device comprising a mounting board for mounting LED chips, a device body having a shape with a bottom part and a cylindrical part integrated for installing the mounting board inside, a lens unit having one or more lenses and installed in front of the LED chips, and a lens unit holding part for holding the lens unit to the device body. By installing the lens unit holding part inside the cylindrical part, the cylindrical part of the device body is exposed to the outside.

In the above-described LED bulb disclosed in Unexamined Japanese Patent Publication No. 2001-243809, the periphery of the plate-like metal substrate is fixed to the opening part of the bugle-shaped metal heat radiation part via the high thermal-conductive member, thereby dissipating heat. However, due to the small contacting area between the metal substrate and the bugle-shaped metal heat radiation part, the thermal resistance can only be reduced to a certain extent.

The LED illuminating device disclosed in Unexamined Japanese Patent Publication No. 2002-299700 describes protrusions formed on the heat-dissipating fastening plate, which constitute cooling fins. In this device, as the substrate is rigid and plane, LEDs are required to be arranged on a flat surface, which narrows its directivity angle.

In the light-emitting diode illumination device described in Unexamined Japanese Patent Publication No. 2003-31005, the plurality of LEDs are arrayed on the concave face. Since the substrate on which the LEDs are mounted is also curved, the mounting steps are complicated.

The illumination device disclosed in Unexamined Japanese Patent Publication No. 2004-327138 has a rigid and plane substrate as in the device described in No. 2002-299700. Therefore, the LEDs have to be arranged on a flat surface, and thus the directivity angle is narrowed.

### SUMMARY OF THE INVENTION

An object of the present invention is to solve the above-described problems of the conventional devices by providing an LED lighting system with a smaller heat resistance of LEDs, which can be produced by simpler mounting steps and is capable of three-dimensionally arranging the LEDs depending on required directivity of each system.

In order to solve the above problems, an LED lighting system of the present invention comprises a plurality of LEDs, a flexible printed circuit board for mounting the LEDs, which is developable in a flat state, and a light source fixing member having a curved surface and made of a high thermal-conductive material, said flexible printed circuit board being tightly attached to the curved surface.

According to the present invention, a plurality of LEDs are mounted on a flexible printed circuit board developed in a flat state, and the flexible printed circuit board is tightly attached to a light source fixing member having a curved surface. As the light source fixing member is made of a high thermal-conductive material such as metal, heat generated in a heated portion of each of the LEDs is directly transmitted to the light source fixing member, thereby minimizing a heat resistance. Here, the “curved surface” is not limited to a smoothly curved surface but contains any non-flat surface such as polyhedrons.

The light source fixing member may be a core which is a central portion of the lighting system. This structure allows each of the plurality of LEDs to face outwardly, providing the lighting system with a wider directivity angle.

The light source fixing member may be a reflector, which provides the lighting system with a directivity toward a focal point of the reflector.

The flexible printed circuit board may be attached to the light source fixing member with a thermal-conductive adhesive. By this structure, the LEDs can be firmly fixed on the light source fixing member, and heat generated from a heated portion of the LEDs can be easily transmitted to the light source fixing member.

According to the LED lighting system of the present invention, a flexible printed circuit board which is developable in a flat state and on which a plurality of LEDs are mounted is tightly attached to a curved surface of a light source fixing member made of a high thermal-conductive material, which reduces a thermal resistance of the LEDs and renders mounting steps simple. In the present invention, the LEDs can be three-dimensionally arranged depending on required directivity of each system.

With the light source fixing member as a core which is a central portion of the lighting system, the system has a wider directivity angle.

By providing a reflector as the light source fixing member, the lighting system has a directivity toward a focal point of the reflector.

As the flexible printed circuit board is attached to the light sourse fixing member with a thermal-conductive adhesive, the LEDs can be firmly fixed on the light source fixing member, thereby reducing heat resistance and improving heat dissipation.

### BRIEF DESCRIPTION OF THE DRAWINGS

In the accompanying drawings:

FIG. 1 is a perspective view illustrating a structure of an LED lighting system according to a first embodiment of the present invention;

FIG. 2 is a plan view of a flexible printed circuit board according to the first embodiment of the present invention;

FIG. 3 is a sectional view of the LED lighting system according to the first embodiment of the present invention;

FIG. 4A is a perspective view of a core with a cover mounted thereon in the first embodiment of the present invention;

FIG. 4B is a perspective view of the cover;

FIG. 5 is a perspective view illustrating a structure of an LED lighting system according to a second embodiment of the present invention;

FIG. 6 is a front view of the LED lighting system according to the second embodiment of the present invention; and

FIG. 7 is a sectional view of the LED lighting system according to the second embodiment of the present invention.

### DETAILED DESCRIPTION OF THE PREFERRED EMBODIMENT

With reference to the accompanied drawings, embodiments of the present invention will be explained below.

### Embodiment 1

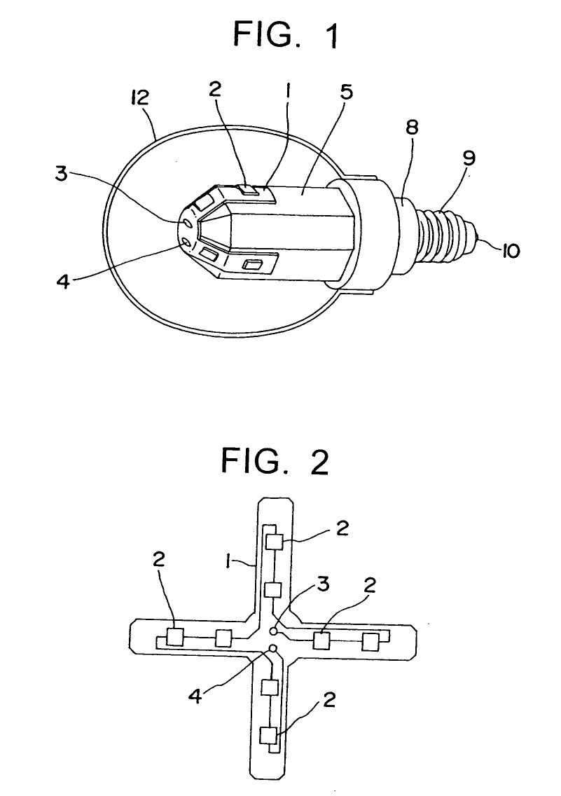

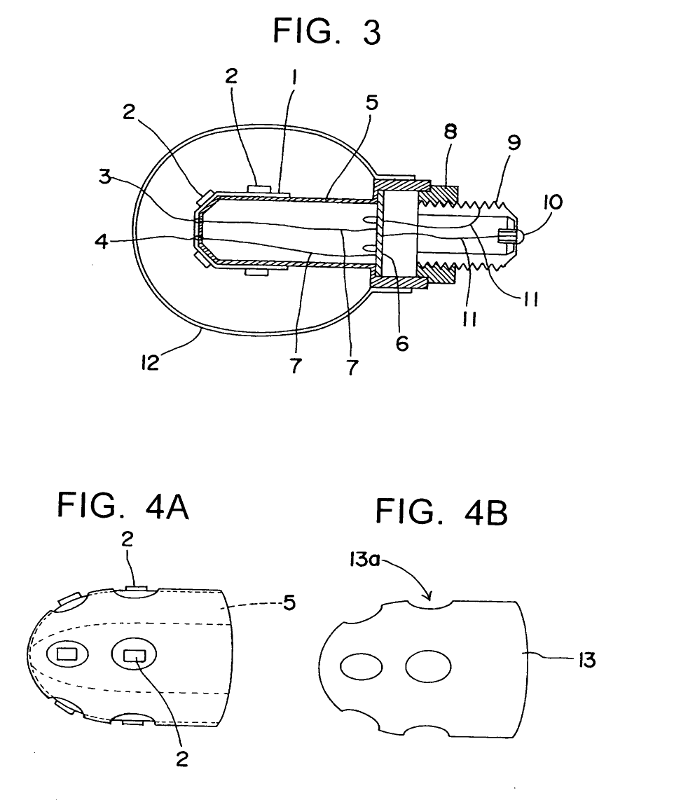

FIG. 1 is a perspective view illustrating a structure of an LED lighting system according to a first embodiment of the present invention; FIG. 2 is a plan view of a flexible printed circuit board according to the first embodiment of the present invention; and FIG. 3 is a sectional view of the LED lighting system according to the first embodiment of the present invention.

In the LED lighting system of the first embodiment, as shown in FIG. 2, a plurality of LEDs 2 are mounted on a flexible printed circuit board (referred to as “FPC” hereinafter) 1 which has a radial shape and can be flat when developed. The LEDs 2 are connected by printed wiring with serial connection to each other, for example, and linked to terminals 3 and 4. As the FPC 1, a thin epoxy substrate or the like can be employed. In the present embodiment, the FPC 1 is attached on a surface of a core 5 made of aluminum and having an outer shape of an octagonal prism using a heat-conductive adhesive such as a thermal-conductive silicon resin, for example. A head portion of the core 5 has a shape of a truncated octagonal pyramid, and the LEDs 2 are arranged on a pyramid portion and a prism portion of the core 5.

The core has a cavity inside to house a power source circuit board 6, which converts AC 100V of a commercial power source into a voltage for driving the LEDs 2. The power source circuit board 6 is connected to the terminals 3 and 4 with wires 7. On a base end of the core 5, a fixing base 8 made of an insulating material is provided, to which a base 9 is fixed. As the fixing base 8, plastic or ceramics can be employed. Use of high thermal-conductive plastic enhances a heat dissipation effect. The base 9 and a solder portion 10 are connected to the power source circuit board 6 by wires 11 inside thereof.

The core 5 may be covered with a cap 12 which surrounds the plurality of LEDs 2. The cap 12 can be made of transparent or semitransparent glass or plastic. If the cap 12 is transparent, each of the plurality of the LEDs 2 is seen as a point source separately. On the other hand, if the cap 12 is semitransparent or opaque white, the cap 12 looks as if its entire surface emitted light due to the effect of diffused reflection. It is not necessary to make a vacuum inside of the cap 2 as in electric bulbs. It is preferable that cap 12 be filled with dry air, inert gases, or the like to prevent the intrusion of dust or humidity.

The FPC 1 can be exposed on a surface of the core 5. It is also possible to dispose a cover 13 over the core 5 as shown in FIG. 4A. The cover 13, as shown in FIG. 4B, has windows 13a formed at the areas which correspond to the positions of the LEDs 2 so that the FPC 1 is covered while only the LEDs 2 are exposed, thereby improving quality of design.

The LED lighting system having the above-described structure is mounted to a socket for an electric bulb, and then 100V of a commercial power source is supplied to the base 9 and the solder portion 10. The power source is applied to the power source circuit board 6 to be converted to a voltage for driving the LEDs 2 so that an appropriate electric current is supplied to the LEDs 2 mounted on the FPC 1. Heat generated at a p-n junction of the LEDs 2 is transmitted to the core 5 via the thermal-conductive adhesive and dissipated. A base end portion of the core 5, which is not shown, can form a fin. Thus, the thermal resistance is decreased by the FPC 1 which is thin and the core 5 which has a large surface area, and heat generated by the LEDs 2 is efficiently dissipated. Accordingly, a plurality of LEDs with high luminous intensity can be used under a condition that a junction temperature of the LEDs is lower than the maximum junction temperature, which optimizes the property of an LED, that is, a longer life.

### Embodiment 2

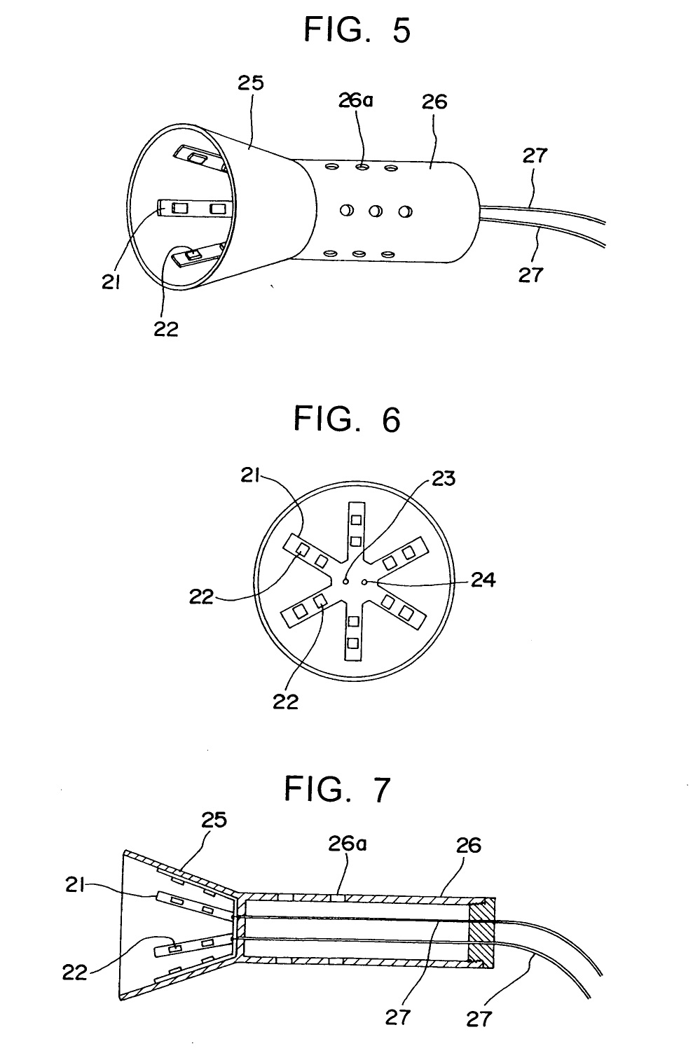

FIG. 5 is a perspective view illustrating a structure of an LED lighting system according to a second embodiment of the present invention; FIG. 6 is a front view thereof; and FIG. 7 is a sectional view of the same.

According to the lighting system of the second embodiment, a plurality of LEDs 22 are mounted on an FPC 21 which has a radial shape and can be flat when developed. The LEDs 22 are connected by printed wiring with serial connection to each other, for example, and linked to terminals 23 and 24. As the FPC 21, a thin epoxy substrate or the like can be employed. The FPC 21 is attached on an inner surface of a reflector 25 made of aluminum using a heat-conductive adhesive such as a thermal-conductive silicon resin, for example. To a base end of the reflector 25, a cylindrical member 26 which has holes 26a for heat dissipation is connected. Wires 27 which connect with the terminals 23 and 24 of the FPC 21 are drawn to an inside of the cylindrical member 26 to be connected to a power source outside the system. As in the case of the first embodiment, a power source circuit board may be installed within the cylindrical member 26.

An electric current is applied to the LED lighting system having the above-described structure to light up the LEDs 22 mounted on the FPC 21. The light reflects inside the reflector 25, converges to some extent, and then radiates from a front side of the reflector 25. Heat generated at a p-n junction of the LEDs 22 is transmitted to the reflector 25 via the FPC 21 and the thermal-conductive adhesive and dissipated to ambient air from an outer surface of the reflector 25 and an outer surface of the cylindrical member 26 connected to the reflector 25. Thus, the thermal resistance is decreased by the FPC 21 which is thin as well as the reflector 25 and the cylindrical member 26 which are exposed to ambient air, and heat generated by the LEDs 22 is efficiently dissipated. Accordingly, a plurality of LEDs with high luminous intensity can be used under a condition that a junction temperature of the LEDs is lower than the maximum junction temperature, which optimizes the property of an LED, that is, a longer life.

The present invention can be utilized in a high luminous intensity LED lighting system with a smaller heat resistance of the LED, which can be produced by simpler mounting steps and is capable of three-dimensionally arranging the LEDs depending on required directivity of each system.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. An LED lighting system comprising:
a plurality of LEDs,
a flexible printed circuit board for mounting the LEDs, which is developable in a flat state, and
a light source fixing member having a curved surface and made of a high thermal-conductive material, said flexible printed circuit board being tightly attached to the curved surface.

2. The system claimed in claim 1, wherein said light source fixing member is a core which is a central portion of the system.

3. The system claimed in claim 1, wherein said light source fixing member is a reflector.

4. The system claimed in claim 1, wherein said flexible printed circuit board is attached to the light source fixing member with a thermal-conductive adhesive.

5. The system claimed in claim 2, wherein said flexible printed circuit board is attached to the light source fixing member with a thermal-conductive adhesive.

6. The system claimed in claim 3, wherein said flexible printed circuit board is attached to the light source fixing member with a thermal-conductive adhesive.
